(19) United States
(12) Patent Application Publication
(10) Pub. No.: US 2025/0080026 A1
(43) Pub. Date: Mar. 6, 2025

(54) METHOD FOR CONTROLLING A PLANAR DRIVE SYSTEM, ROTOR, STATOR ASSEMBLY AND PLANAR DRIVE SYSTEM

(71) Applicant: Beckhoff Automation GmbH, Verl (DE)

(72) Inventors: Lukas Bentfeld, Delbrück (DE); Johannes Beckhoff, Schloß Holte-Stukenbrock (DE); Felix Schulte, Rietberg (DE); Uwe Prüssmeier, Lemgo (DE)

(21) Appl. No.: 18/941,599

(22) Filed: Nov. 8, 2024

Related U.S. Application Data
(63) Continuation of application No. PCT/EP2023/062241, filed on May 9, 2023.

(30) Foreign Application Priority Data
May 11, 2022 (DE) 10 2022 111 832.0

(51) Int. Cl. H02P 25/064; H02K 41/03; H02P 6/00; H02P 6/16

(52) U.S. Cl. CPC H02P 25/064; H02K 41/031; H02P 6/006; H02P 6/16; H02K 2201/18

(57) ABSTRACT

A method for controlling a planar drive system includes transmitting a communication message with the aid of a main controller to a sub-controller via the communication system, where the communication message comprises a start command for starting the automation process to be carried out by the rotor and is configured to drive the sub-controller to control the automation process, and receiving a response message transmitted by the sub-controller to the main controller via the communication system, the response message comprising a status indication of a status of the automation process controlled by the sub-controller. The application also provides a rotor, a stator assembly and a planar drive system.

### CROSS REFERENCE TO RELATED APPLICATIONS

This is a continuation of International Patent Application No. PCT/EP2023/062241, filed May 9, 2023, entitled “Method for Controlling a Planar Drive System, Rotor, Stator Unit and Planar Drive System,” which claims the priority of DE 10 2022 111 832.0 filed May 11, 2022, entitled “Verfahren zum Steuern eines Planarantriebssystems, Läufer, Statoreinheit und Planarantriebssystem,” the contents of each of which are hereby incorporated by reference herein, in the entirety and for all purposes.

### TECHNICAL FIELD

The application relates to a method for controlling a planar drive system, a rotor and a stator assembly of a planar drive system and a planar drive system which is set up to carry out the method for controlling a planar drive system.

### BACKGROUND

Planar drive systems may be used in automation technology, in particular in production technology, handling technology and process engineering. Planar drive systems may be used to move or position a moving element of a system or of a machine in at least two linearly independent directions. Planar drive systems may comprise a permanently energized electromagnetic planar motor having a planar stator and a rotor that may move on the stator in at least two directions.

In a permanently energized electromagnetic planar motor, a drive force is exerted upon the rotor by creating a magnetic coupling between a magnetic field of the rotor and a magnetic field of a stator assembly. The magnetic field of the rotor may be generated via permanent magnets arranged on the rotor. The magnetic field of the stator assembly, on the other hand, may be generated by energizing a plurality of stator coils.

By controlling the current supply to the various stator coils accordingly, it is possible to drive the rotor via the magnetic coupling with the magnetic field of the rotor. Since both the magnetic field of the rotor and the controllable magnetic fields of the stator assembly have components that are oriented in parallel to a surface of the stator assembly, the rotor may be moved in any direction parallel to the surface of the stator assembly. By coupling components of the magnetic fields of the rotor and of the stator assembly that are oriented perpendicular with regard to the surface of the stator assembly, the rotor may be brought into a floating state above the surface of the stator assembly or held in this state.

For such planar drive systems, which are primarily used for the transportation of goods to be transported, it may be advantageous to carry out processes relating to the respective goods directly on the respective rotor during the transportation of the goods. These processes may include, for example, reorienting the goods to be transported on the rotor or processing the goods to be transported.

A method for controlling a planar drive system and a planar drive system is known from publication WO 2022/079070 A1.

### SUMMARY

The present application provides an improved method for controlling a planar drive system, a rotor, a stator assembly and a planar drive system.

### EXAMPLES

According to an aspect of the application, a method for controlling a planar drive system is provided, wherein the planar drive system comprises a main controller for controlling the planar drive system, a stator assembly with a plurality of stator coils for generating a stator magnetic field and at least one rotor with a plurality of magnet assemblies for generating a rotor magnetic field, wherein the rotor is drivable on the stator assembly via a magnetic coupling between the stator magnetic field and the rotor magnetic field, wherein a sub-controller is embodied on the rotor for controlling an automation process executable by the rotor, wherein the planar drive system further comprises a communication system for wireless data communication between the main controller and the sub-controller of the rotor, and wherein the method comprises:
transmitting a communication message by the main controller to the sub-controller via the communication system in a transmitting step, the communication message comprising a start command for starting the automation process to be executed by the rotor and being configured to drive the sub-controller to control the automation process; and
receiving a response message sent by the sub-controller to the main controller via the communication system in a receiving step, wherein the response message comprises a status information about a status of the automation process controlled by the sub-controller.

This may achieve the technical advantage that an improved method for controlling a planar drive system may be provided. For this purpose, at least one rotor of the planar drive system is provided having a sub-controller, which is set up to control an automation process that may be executed on the rotor or by the rotor. The planar drive system also comprises a main controller, which is set up to control the entire planar drive system, including the drive of the at least one rotor, via a corresponding actuation of the stator assembly of the planar drive system. The main controller is also set up to cause the sub-controller, via a communication system of the planar drive system, to start the automation process that may be controlled by the sub-controller of the rotor and to control it accordingly.

The sub-controller is in this context set up to control the automation process independently of the main controller. The independent control of the automation process by the sub-controller in this context describes that the main controller is only set up to cause the sub-controller to start the execution of the automation process with a corresponding communication message and a start command contained therein. However, the main controller is not set up to intervene in the execution of the automation process or to start or end the automation process without the sub-controller. The sub-controller, on the other hand, is set up to start the automation process independently after receiving the start command, to control it and, if necessary, to end the automation process when the process target to be achieved is reached or to interrupt it if a malfunction is observed or if it becomes apparent that the target to be achieved by the automation process cannot be achieved.

The sub-controller of the rotor is also set up to send a response message to the main controller via the communication system, with the response message comprising status information relating to a status of the automation process controlled by the sub-controller. By outputting the response message, the automation process of the rotor controlled by the sub-controller may be integrated into the control of the entire planar drive system by the main controller. For this purpose, the status information may include process data of the automation process or start, stop or interruption information of the automation process controlled by the sub-controller. The status information of the automation process may be integrated into the control of the planar drive system by the main controller by controlling further processes executed by the planar drive system, taking into account the status information of the automation process carried out by the rotor.

This achieves the technical advantage that individual sub-processes of the main process to be carried out by the entire planar drive system may be outsourced to different rotors in a decentralized manner.

By controlling the automation process of the rotor through the sub-controller embodied on the rotor, the control of the entire planar drive system by the main controller may be simplified in that control processes that are required to control the automation process to be executed on the rotor are carried out exclusively by the sub-controller. The main controller therefore does not have to carry out these control processes.

Furthermore, it may be achieved that a reduction in the data volume of a data communication between the main controller and a processing device executing the automation process may be reduced. Only data communication between the sub-controller and the processing device carrying out the automation process is required to control the automation process. If this processing device is also embodied on the rotor, the data communication required to control the automation process may also be effected exclusively on the rotor.

The data communication between the rotor and the main controller may in this context be reduced to the sending of the response message, including the status information contained therein, by the sub-controller to the main controller. For the purposes of the application, the data communication between the main controller and the rotor describes in particular a data communication between the main controller and the sub-controller embodied on the rotor.

The reduced data volume of the data communication between the main controller and the rotor or the sub-controller embodied on the rotor allows for improved and accelerated control of the planar drive system, in that the bandwidth of the data communication within the planar drive system saved as a result may be used for other functionalities of the planar drive system.

### BRIEF DESCRIPTION OF THE DRAWINGS

The invention is described in more detail with reference to the attached figures, which show:

FIG. 1 is a schematic depiction of a planar drive system having a stator assembly and a rotor according to an embodiment;

FIG. 2 is a schematic depiction of a stator module of the stator assembly in FIG. 1;

FIG. 3 is a schematic depiction of the bottom side of a rotor according to an embodiment;

FIG. 4 is a schematic exploded view of a stator segment of the stator assembly in FIG. 1 according to a further embodiment;

FIG. 5 is a flow chart of a method for controlling a planar drive system according to an embodiment;

FIG. 6 is a further flow chart of the method for controlling a planar drive system according to a further embodiment;

FIG. 7 is a further flow chart of the method for controlling a planar drive system according to a further embodiment;

FIG. 8 is a schematic depiction of the method for controlling a planar drive system according to the embodiment in FIG. 7;

FIG. 9 is a schematic depiction of a rotor of the planar drive system according to an embodiment;

FIG. 10 is a further schematic depiction of a rotor of the planar drive system according to a further embodiment;

FIG. 11 is a further schematic depiction of a rotor of the planar drive system according to a further embodiment; and

FIG. 12 is a schematic depiction of various embodiments of a sub-controller of a rotor.

### DETAILED DESCRIPTION

According to an embodiment, the communication system comprises a plurality of communication units arranged in a distributed manner on the stator assembly and rotor communication units arranged in a distributed manner on the rotor, wherein the transmitting step carried out by the main controller comprises:
determining at least one communication unit arranged adjacent to a position of the rotor on the stator assembly in a determining step; and
controlling the communication unit adjacent to the position of the rotor to send the communication message in an actuating step.

This has the technical advantage of allowing for precise data communication between the main controller of the planar drive system and the sub-controller on the rotor. In order to control the rotor, the position of the rotor on the stator assembly is known to the main controller at all times. For this purpose, the planar drive system comprises a plurality of magnetic field sensors embodied in the stator assembly, via which the rotor magnetic field of the rotor may be detected and the position of the rotor on the stator assembly may be determined.

If the position of the rotor is known, only the communication units that are arranged in the stator assembly adjacent to the position of the rotor may thus be selected for transmission of the information message by the main controller to the sub-controller. Communication units adjacent to the position of the rotor may be characterized according to the application in that they do not exceed a predefined maximum distance from the determined position of the rotor.

The corresponding communication message is therefore sent to the rotor exclusively via the communication units of the stator assembly arranged adjacent to the rotor in the respective position. This allows for improved data communication between the main controller and the sub-controller on the rotor. Particularly in the case of a plurality of rotors that are actuated by the main controller on the stator assembly, the selection of the communication units for sending communication messages may ensure that the communication messages sent are only sent to the respective addressed sub-controllers of the rotors. This may prevent the main controller from sending messages to non-addressed sub-controllers.

According to an embodiment, the receiving step performed by the main controller comprises:
determining at least one communication unit arranged adjacent to the position of the rotor on the stator module in a further determining step; and
reading out the communication unit adjacent to the position of the rotor to receive the response message in a reading-out step.

This has the technical advantage of allowing for precise data communication between the sub-controller on the rotor and the main controller of the planar drive system. For this purpose, the main controller only reads out the communication units that are embodied in the stator assembly adjacent to the current position of the rotor after the response message has been sent by the rotor's sub-controller.

This means that it is not necessary to read out all the communication units in the stator assembly in order to receive the response message from the sub-controller. Particularly in the case of a plurality of rotors having corresponding sub-controllers, each of which transmits response messages to the main controller, the selection of the communication units of the stator assembly adjacent to the respective positions of the rotors is advantageous in that the different response messages transmitted by the sub-controllers of the different rotors may be clearly assigned to the respective rotor. Misinterpretation of the received response messages due to incorrect assignment of the messages to the respective sub-controllers of the rotors and the automation processes carried out on or by these may thus be avoided.

According to an embodiment, the data communication between the main controller and the sub-controller takes place during a driving of the rotor from a first position to a second position on the stator assembly, wherein the transmitting step carried out by the main controller comprises a transmitting step:
determining at least one first communication unit arranged adjacent to the first position of the rotor on the stator assembly in a first communication unit determining step; and
driving the first communication unit adjacent to the first position of the rotor to transmit a first communication partial message in a first partial transmitting step, the first communication partial message representing a part of the communication message; and
determining at least one second communication unit disposed adjacent to the second position of the rotor on the stator assembly in a second communication unit determining step; and
driving the second communication unit adjacent to the second position of the rotor to transmit a second communication partial message in a second partial transmitting step, wherein the second communication partial message represents a further part of the communication message; and/or wherein the receiving step carried out by the main controller comprises: determining at least one first communication unit arranged adjacent to the first position of the rotor on the stator assembly in a further first communication unit determining step; and
reading out the first communication unit adjacent to the first position of the rotor to receive a first partial response message in a first partial reading-out step, the first partial response message representing a part of the response message; and
determining at least one second communication unit arranged adjacent to the second position of the rotor on the stator assembly in a further second communication unit determining step; and
reading out the second communication unit adjacent to the second position of the rotor for receiving a second partial response message in a second partial reading-out step, the second partial response message representing a further part of the response message.

This may achieve the technical advantage of allowing for precise data communication between the main controller and the sub-controller during a movement of the rotor between two positions on the stator assembly. For this purpose, the communication messages or response messages to be transmitted are divided up into at least two communication partial messages or two response partial messages and a corresponding first communication or response partial message is transmitted via first communication units adjacent to a first position of the rotor and a corresponding second communication or response partial message is transmitted via second communication units adjacent to a second position of the rotor.

For this purpose, the main controller first determines a first position of the rotor and first communication units are selected which are arranged in the stator assembly adjacent to the first position of the rotor, and a corresponding first communication partial message is sent to the sub-controller of the rotor via the selected first communication units or a corresponding first response partial message is received by reading out the selected first communication units.

At a later time, the second position of the rotor is determined and corresponding second communication units are selected, which are arranged adjacent to the second position in the stator assembly. By actuating the selected second communication units, a corresponding second partial communication message is sent to the sub-controller or, by reading out the selected second communication units, a second partial response message is received by the main controller.

The first and second communication partial messages are each parts of the entire communication message to be transmitted, while the first and second response partial messages represent corresponding parts of the entire response message to be transmitted.

In this way, it may particularly be achieved that, in the case of cyclical control of the planar drive system, in which the functionalities of the planar drive system are controlled by the main controller in corresponding control cycles, a communication message may be transmitted by the main controller or a response message may be received, the scope of which cannot be transmitted completely in one control cycle. For this purpose, the first communication partial message or the first response partial message is transmitted via the first communication units in a first control cycle, while the second communication partial message or the corresponding second response partial message, which in each case represents the remainder of the entire communication message or response message that could not be transmitted during the first control cycle, is transmitted via the second communication units in the immediately following later control cycle.

In this context, it is assumed that the rotor was moved from the first position to the second position in the subsequent control cycle as a result of the movement of the rotor.

This ensures that precise data communication between the main controller and the sub-controller may be achieved even when the rotor is moving and when the rotor is controlled cyclically, so that all data to be transmitted may be exchanged without errors.

According to an embodiment, the response message or partial response message received by the main controller via the communication unit is assigned to the sub-controller of the rotor based on a position of the communication unit on the stator assembly via which the response message or partial response message was received and the position of the rotor when the response message or partial response message was received by the main controller.

This has the technical advantage that the respective sub-controller of the respective rotor may be addressed via the position of the rotor known to the main controller. Explicit addressing of the rotor's sub-controller within the transmitted communication message is therefore not necessary. Similarly, a response message received by the main controller may be uniquely assigned to the sub-controller of this rotor based on the known position of the rotor. Explicit identification of the rotor's sub-controller is therefore also not necessary.

According to an embodiment, the status information of the response message received by the main controller comprises start information that the automation process has been started and/or stop information that the automation process has been stopped and/or process data of the completed automation process and/or process data as partial result information of the running automation process and/or an error message regarding an incorrect execution of the automation process.

This may achieve the technical advantage that precise information regarding the status of the automation process controlled by the sub-controller may be provided to the main controller. This allows for precise control of the planar drive system, in which the results of the automation process controlled by the sub-controller may be taken into account.

According to an embodiment, the main controller and the sub-controller each comprise a clock element, wherein the communication message further comprises a time stamp for synchronizing the clock elements of the main controller and of the sub-controller.

This has the technical advantage that the execution of the automation process may be precisely integrated into the control of the entire planar drive system. For this purpose, clock elements of the main controller and of the sub-controller are synchronized with one another based on the time stamp provided by the main controller. Based on the synchronized clock elements, a precise temporal classification of the execution of the automation process controlled by the sub-controller into the overall process of controlling the planar drive system may thus be achieved. This may further improve the control of the planar drive system.

According to an embodiment, the communication message comprises a start time for starting the execution of the automation process by the sub-controller.

This may achieve the technical advantage that a precise start time for the execution of the automation process may be defined. This in turn allows the timing of various sub-processes within the overall process of controlling the planar drive system to be achieved, which in turn helps to improve the control of the planar drive system.

According to a further aspect, a rotor for a planar drive system is provided with a stator module for generating a stator magnetic field for driving the rotor via a magnetic coupling with a rotor magnetic field of the rotor, wherein the rotor comprises a plurality of magnet assemblies for generating the rotor magnetic field, a sub-controller for controlling an automation process, a processing device with at least one actuator unit and/or a sensor unit for executing the automation process, and a rotor communication unit for executing data communication between the sub-controller of the rotor and a main controller of the planar drive system.

In this way, the technical advantage may be achieved that an improved rotor may be provided for a planar drive system, wherein the rotor is set up via a sub-controller embodied on the rotor to control an automation process individually and independently of the main controller of the planar drive system. Furthermore, the rotor is set up to communicate with the main controller of the planar drive system via a communication system of the planar drive system, consisting of rotor communication units arranged in a distributed manner on the rotor and communication units arranged in a distributed manner on the stator assembly. The sub-controller embodied on the rotor for controlling the automation process allows for decentralizing the control of an overall process of the planar drive system. The automation process controlled by the sub-controller represents a sub-process of the overall process of the planar drive system. By controlling the automation process via the sub-controller, the control processes of the main controller may be simplified in that the automation process is controlled exclusively by the sub-controller of the rotor.

According to an embodiment, the sub-controller is layered and evenly distributed over a surface of the rotor.

This has the technical advantage that the uniformly flat embodiment of the sub-controller on the rotor may achieve an even weight distribution of the rotor. The uniform weight distribution, in which the center of gravity of the rotor is arranged as far as possible in a geometric center of the rotor, allows for a more precise floating or flight behavior of the rotor above the stator surface of the stator assembly. The uniform weight distribution of the rotor due to the flat embodiment of the sub-controller means that tilting of the rotor relative to the stator surface of the stator assembly may be prevented.

According to an embodiment, the sub-controller is arranged below the processing device or to the side of the processing device.

This has the technical advantage of allowing for a space-saving arrangement of the sub-controller and the processing device on the rotor.

According to a further aspect, a stator assembly for a planar drive system with at least one rotor is provided, wherein the stator module comprises a plurality of stator coils for generating a stator magnetic field for driving the rotor via a magnetic coupling with a rotor magnetic field of the rotor and a plurality of communication units arranged in a distributed arrangement on the stator assembly for data communication between a main controller of the planar drive system and a sub-controller embodied on the rotor.

This may achieve the technical advantage that an improved stator assembly for a planar drive system may be provided, which allows for precise data communication between the main controller of the planar drive system and a sub-controller embodied on a rotor of the planar drive system. For this purpose, the stator assembly comprises a plurality of communication units which are embodied in an arrangement on the stator assembly and allow for data communication between the main controller and the sub-controller of the rotor.

According to an embodiment, a maximum distance between two neighboring communication units on the stator assembly of the arrangement is less than or equal to twice the maximum communication range of the communication unit.

This may achieve the technical advantage of allowing for seamless data communication between the main controller of the planar drive system and the sub-controller of the rotor for any position of the rotor on the stator assembly. For this purpose, the communication units in the arrangement on the stator assembly are arranged at distances from each other that are less than or equal to twice the communication range of the communication units.

By ensuring that the distances between the communication units of the stator assembly are equal to or smaller than twice the communication range of the communication units, it may be achieved that for any position of the rotor, the rotor communication unit embodied on the rotor is always positioned within the communication range of at least one communication unit of the stator assembly. This allows for continuous, uninterrupted data communication between the main controller of the planar drive system and the sub-controller of the rotor, which may also be provided while the rotor is moving. The communication range of the communication units describes a maximum distance to the respective communication unit within which error-free wireless data communication between the communication unit and the rotor communication unit may be guaranteed.

For the purposes of the application, a communication range of the communication units and of the rotor communication units is a maximum distance that two communication units or rotor communication units have to each other without interference with the data communication between the communication units and/or rotor communication units.

According to an embodiment, a maximum distance between two neighboring communication units on the stator assembly is less than or equal to a minimum planar extent of a rotor of a planar drive system.

This may achieve the technical advantage of allowing for seamless data communication between the main controller of the planar drive system and the sub-controller of the rotor. By creating distances between directly adjacent communication units of the stator assembly that are smaller than or equal to the smallest planar extension of the rotor, it is possible to ensure that the rotor at least partially covers at least one communication unit of the stator assembly for any position of the rotor. This allows for ensuring that the rotor or the at least one rotor communication unit embodied on the rotor is positioned within the communication range of at least one communication unit embodied in the stator assembly for each position of the rotor.

According to an embodiment, the stator coils are set up by a cyclical actuation to drive the rotor at a maximum speed over a maximum distance that may be covered within a control cycle, wherein the maximum distance that may be covered by the rotor in a control cycle is less than or equal to a communication range of the communication units and/or less than or equal to a maximum distance between two neighboring communication units.

This may achieve the technical advantage of ensuring seamless data communication between the main controller of the planar drive system and the sub-controller of the rotor. For this purpose, the distances between the communication units embodied in the stator assembly are smaller than or equal to a maximum distance that the rotor may cover relative to the stator assembly during a control cycle. This allows for ensuring that the rotor is positioned within a communication range of at least one communication unit of the stator assembly at all times, even while the rotor is moving relative to the stator assembly, thus ensuring data communication between the sub-controller of the rotor and the main controller of the planar drive system at all times.

According to an embodiment, the communication units of the stator assembly comprise transmitting/receiving units of a near-field communication and/or a Bluetooth communication and/or a ZigBee communication and/or a Z-wave communication.

The at least one rotor communication unit arranged on the rotor also comprises transmitting/receiving units. These comprise an embodiment that is compatible with the communication units in terms of the communication technology used.

According to an embodiment, the communication units of the stator assembly and the rotor communication units of the rotor are of the same type.

This may achieve the technical advantage of ensuring reliable data communication between the main controller of the planar drive system and the sub-controller of the rotor. The technical advantage of near-field communication lies in the favorable embodiment of the communication units or rotor communication units, as well as in the technically less complex embodiment of the communication protocol. In particular, data communication may take place without a handshake between the two communication partners, the main controller and the sub-controller.

According to an embodiment, the communication units are embodied in a communication foil, with the communication foil being embodied on a stator surface of the stator module.

The has the technical advantage of allowing for the communication units to be embodied on the stator assembly in a simple manner. For this purpose, the communication units may be arranged in a communication foil, which in turn may be positioned on the stator surface of the stator assembly. This allows for simple and cost-effective production of the communication system. By arranging the communication units on the stator surface, the communication units are arranged directly between the rotor and the stator surface. This prevents shielding of the communication units by the stator coils of the stator assembly and ensures interference-free data communication via the communication units of the stator assembly and the rotor communication units of the rotor. The communication units and the communication foil may in turn be made correspondingly thin so that the magnetic coupling of the rotor magnetic field of the rotor and the stator magnetic fields of the stator coils is not weakened. The communication foil, which may be produced from a plastic material, may also serve as a protective layer for the stator surface.

According to an embodiment, the communication units are integrated into the stator module.

This may achieve the technical advantage that the communication units are robust and secured to the stator assembly. By integrating the communication units into the stator assembly, the communication units are protected against damage. This in turn may improve data communication.

According to a further aspect, a planar drive system is provided which comprises a main controller for controlling the planar drive system, a rotor according to one of the preceding embodiments and a stator module according to one of the preceding embodiments, wherein the planar drive system is set up to carry out the method according to the application according to one of the preceding embodiments.

This may achieve the technical advantage that an improved planar drive system with a rotor according to the application with the above-mentioned technical advantages and a stator assembly according to the application with the above-mentioned technical advantages may be provided, which is set up to carry out the method according to the application for controlling a planar drive system with the above-mentioned technical advantages.

According to an embodiment, the communication system comprises at least one external communication unit, wherein the external communication unit is arranged at a distance from the stator assembly.

This may achieve the technical advantage that the external communication unit, which is positioned at a distance from the stator assembly, allows for interference-free communication between the main controller and the sub-controllers of the rotors for any position of the rotors on the stator assembly. For this purpose, the external communication unit may be arranged next to or above the stator assembly and have a communication range that is suitable for encompassing the rotors in any position on the stator assembly.

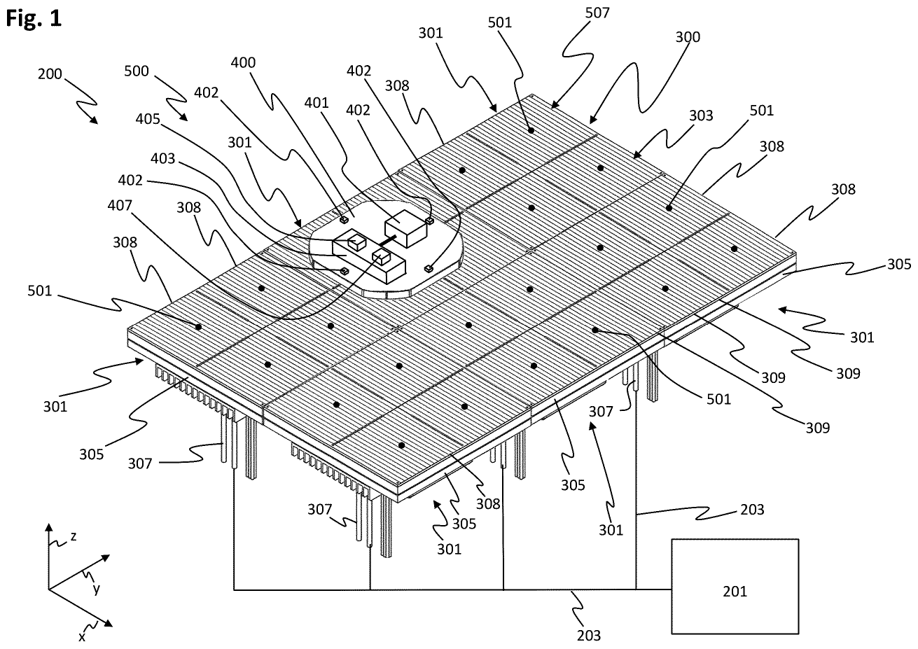

FIG. 1 shows a schematic view of a planar drive system 200 having a stator assembly 300 and a rotor 400.

According to the embodiment in FIG. 1, the planar drive system 200 comprises a main controller 201, a stator assembly 300 and a rotor 400. The main controller 201 is connected to the stator assembly 300 via a data connection 203. The main controller 201 is set up to actuate the stator assembly 300 by sending corresponding control signals via the data connection 203 to the stator assembly 300 to move the rotor 400 accordingly. The main controller 201 is also set up to carry out a method 100 according to the application for controlling a planar drive system 200.

According to the application, the rotor 400 comprises a sub-controller 401 and a processing device 403. The sub-controller 401 is embodied to control an automation process which is carried out by the processing device 403. For this purpose, the processing device 403 comprises at least an actuator unit 405 and/or a sensor unit 407, with the aid of which the automation process may be executed. The automation process may be embodied as a partial process of a superordinate process to be executed by the entire planar drive system 200. The sub-controller 401 of the rotor 400 is in this context set up to control the automation process independently and to have it executed by the processing device 403. The sub-controller 401 and the processing device 403 are connected to each other by data technology for this purpose, so that the processing device 403 may be actuated by the sub-controller 401. The sub-controller 401 may, for example, be embodied as a programmable logic controller PLC, and the automation process may be controlled cyclically.

The automation process controlled by the sub-controller 401 may, for example, be an arrangement or orientation process in which a good to be transported by the rotor 400 is brought into a desired arrangement or orientation on the rotor 400. For this purpose, the processing device 403 may, for example, comprise a gripper arm with the aid of which the orientation or arrangement of the goods on the rotor 400 may be changed.

As an alternative or in addition, the automation process may comprise a loading process. For example, objects or items may be unloaded from the rotor 400 with the aid of a gripper arm of the processing device 403 or another loading device and positioned on other rotors 400 or on positioning devices of the planar drive system 200 provided for this purpose. The gripper arm of the processing device 403 may also be used to load goods from one rotor 400 onto a further rotor 400. Alternatively, the gripper arm may also be positioned on the rotor 400 and goods not positioned on the rotor 400 may also be moved by the gripper arm. For example, the gripper arm may be used to place goods on the rotor 400, on another rotor or at a position provided for this purpose that is not arranged on the stator assembly.

As an alternative or in addition, the processing device 403 may comprise a camera unit, with the aid of which processes may be observed that are executed on the same rotor 400 or on other rotors 400 of the planar drive system 200. The observation process may be executed via the sub-controller 401. The camera unit may, for example, be embodied as a smart camera that allows for recognizing objects with the aid of appropriately trained artificial intelligence.

As an alternative or in addition, the automation process may comprise a manufacturing or processing process in which processing of a good to be transported or manufacturing of an object or item from the good to be transported is achieved. For example, the automation process may comprise a heating or cooling process in which the goods to be transported are heated or cooled to or maintained at a predetermined temperature. For this purpose, the processing device 403 may comprise at least one heating or cooling element and a temperature sensor. By heating or cooling, for example, the aggregate state of the goods to be transported may be changed and, if necessary, a mixing or segregation of different components of the goods to be transported may be achieved. As an alternative or in addition, the processing device 403 may also merely be used to monitor the temperature of the goods to be transported, wherein this is maintained at a constant temperature, for example.

As an alternative or in addition, the processing device 403 may be configured to carry out a weighing process to determine a mass of the goods to be transported.

The automation process to be controlled by the sub-controller 401 may be carried out while the rotor 400 is moving between two positions on the stator assembly 300. Alternatively, the rotor 400 may be moved to a position provided for this purpose on the stator assembly 300 in order to carry out the automation process. Alternatively, the automation process to be controlled may also be executed by the movement of the rotor 400 itself, for example by rotating the rotor at a defined speed in order to mix transported liquids with one another or to separate them from one another in accordance with a centrifuge.

In order to integrate the automation process controlled by the sub-controller 401 of the rotor 400 into the superordinate automation process to be controlled or carried out by the entire planar drive system 200, the planar drive system 200 further comprises a communication system 500, with the aid of which communication between the main controller 201 of the planar drive system 200 and the sub-controller 401 of the rotor 400 is made possible. Via the communication between the main controller 201 and the sub-controller 401 of the rotor 400, a start command or a stop command of the main controller 201 may initiate a start or stop of the automation process. Furthermore, status information regarding the executed automation process and/or process data may be provided by the sub-controller 401 of the main controller 201.

The data communication between the main controller 201 and the sub-controller 401 of the rotor 400 may also include cyclical data communication. For this purpose, corresponding messages may be transmitted or received in predetermined communication cycles by the main controller 201 or the sub-controllers 401 at predetermined times. The communication cycles may be given by control cycles, according to which cyclic control of the planar drive system 200 or the executed automation process takes place.

For example, the rotor 400 or the sub-controller 401 of the rotor 400 may permanently send sensor values or other information in corresponding messages to the main controller 301 for the specified communication cycles. The data transmitted cyclically by the sub-controller 401 may then be processed by the main controller 201 and its information integrated into the control of the automation process to be controlled. For this purpose, the main controller may cyclically send corresponding communication messages to the sub-controller 401 of the rotor 400.

Alternatively, the main controller may transmit a communication message to the sub-controller 401 of the rotor 400 once, with the aid of which the rotor 400 is requested to transmit the corresponding data cyclically. Alternatively, the sub-controller 401 may also be triggered to send data cyclically to the main controller 201 independently, i.e. without a prior communication message from the main controller 201.

As the case may be, based on the data from the sub-controller 401, corresponding subsequent commands may be sent to the sub-controller 401 in corresponding communication messages by the main controller 201. In particular, commands or instructions or information may be exchanged between the main controller 201 and the sub-controller 401 in the prescribed cycle times of the communication cycles.

In order to provide communication, the communication system 500 comprises a plurality of communication units 501 distributed on the stator assembly 300 and at least one rotor communication unit 402 embodied on the rotor 400.

In the embodiment shown, the rotor 400 comprises four rotor communication units 402 arranged at the four edges of the square shaped rotor 400. In deviation therefrom, the rotor 400 may comprise any number of rotor communication units 402 embodied at any positions on the rotor 400. According to an embodiment, the rotor communication units 402 each comprise antenna units for receiving and transmitting messages and evaluation units for evaluating the received messages. The antenna units and evaluation units of a rotor communication unit 402 may each be embodied at different positions on the rotor 400.

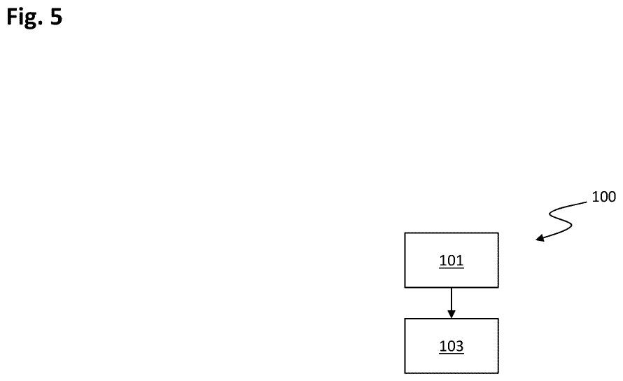

For a detailed description of the method according to the application for controlling a planar drive system 200, please refer to the description of FIG. 5 to FIG. 8.

In the embodiment shown, the stator assembly 300 comprises a plurality of stator modules 301 arranged side by side along an X-direction and a Y-direction of the stator assembly 300 and forming a contiguous planar stator surface 303 of the stator assembly 300. In the embodiment shown, the stator assembly 300 comprises six stator modules 301. However, the number of interconnected stator modules 301 of a stator assembly 300 is not intended to be limited to this and may vary as desired. In the embodiment shown, the main controller 201 is connected to each stator module 301 via the data connection 203, so that each stator module 301 may be actuated individually. Control signals and/or communication messages of the main controller 201 may be forwarded from one stator module 308 to another stator module 308 via the data connection 203.

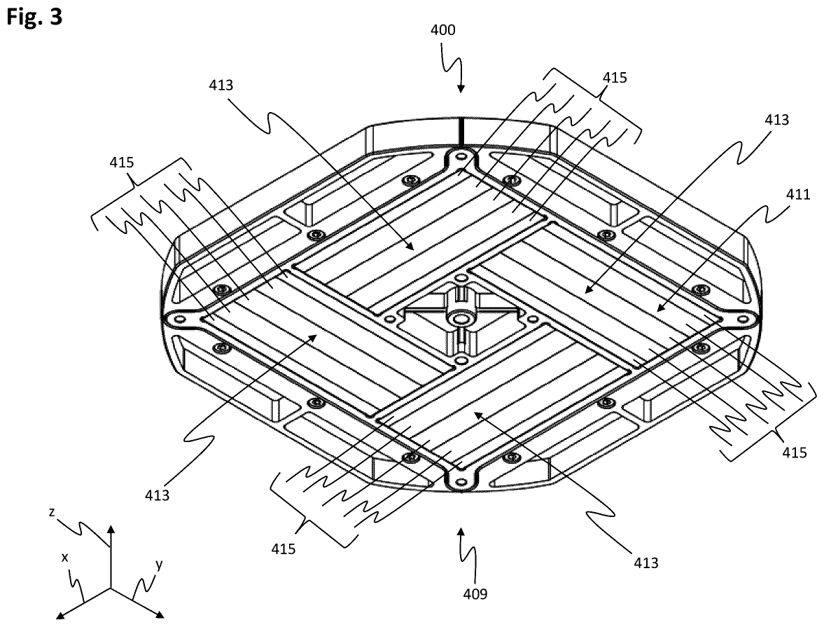

Each of the stator modules 301 comprises four stator segments 308. Each stator segment 308 comprises X-coil groups and Y-coil groups, each of which is oriented along the X-direction or the Y-direction. For a detailed description of the coil groups, please refer to FIG. 3. Alternatively, a stator module 301 may comprise any number of stator segments 308.

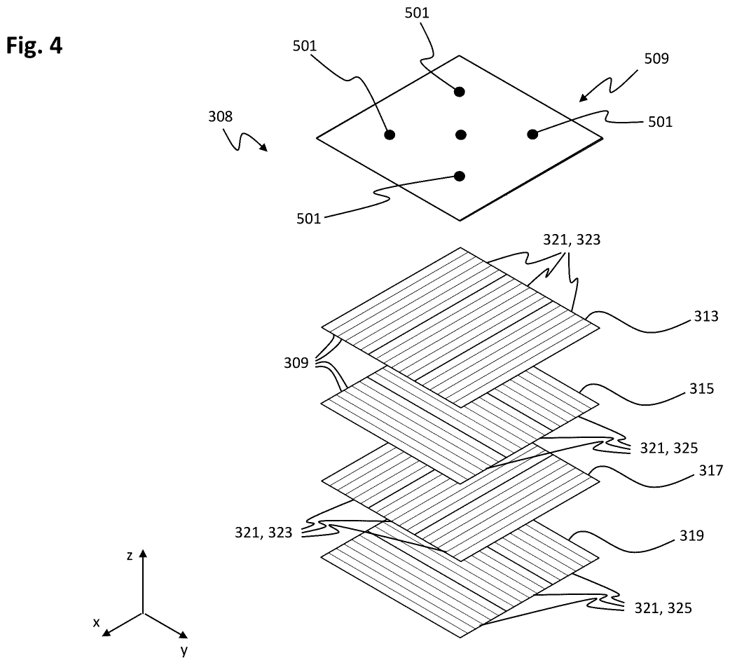

In the embodiment shown, the stator segments 308 are square and are arranged in alignment along the X-direction and the Y-direction. A rectangular or otherwise shaped configuration of the stator segments 308 is also possible. Each stator segment 308 comprises a plurality of energizable stator conductors 309, which are combined in the coil groups as described in FIG. 4 and are oriented along the X-direction or along the Y-direction.

In FIG. 1, only stator conductors 309 oriented along the X direction are shown. Stator magnetic fields may be generated by energizing the stator conductors 309 of the coil groups. With the aid of a magnetic coupling between the stator magnetic fields and a rotor magnetic field of the rotor 400, the rotor 400 may be driven in a floating manner along the X-direction and the Y-direction via the stator surface 303. By moving the rotor 400 both in the X-direction and in the Y-direction, the rotor 400 may be moved in any direction over the stator surface 303. It is also possible to move the rotor 400 in a Z-direction oriented perpendicular with regard to the X-direction and the Y-direction. In this way, the distance between the rotor 400 and the stator surface 303 may be varied, i.e. the rotor 400 may be raised or lowered above the stator surface 303. It is also possible to rotate the rotor 400 about an axis of rotation oriented perpendicular with regard to the stator surface 303 or to tilt the rotor 400 about an axis of rotation oriented in parallel to the stator surface 303.

The stator modules 301 each comprise a stator module housing 305, in which control electronics are arranged to control the stator module 301. Furthermore, magnetic field sensors for detecting the rotor magnetic field of the rotor 400 are arranged in the stator module housing 305. Each stator module 301 comprises corresponding connection lines 307 for supplying power and data to the control electronics.

In the embodiment shown, the communication system 500 comprises a plurality of communication units 501 embodied on the stator assembly 300. The rotor 400 comprises rotor communication units 402. The communication units 501 thus allow for communication between the main controller 201 and the rotor 400 or the sub-controller 401 arranged on the rotor 400 in communicative connection with the rotor communication units 402.

In the embodiment shown, the communication units 501 are evenly distributed over the entire stator assembly 300. In the embodiment shown, the communication units 501 are arranged in a communication foil 507. The communication foil 507 may be made of a plastic material and positioned on the stator surface 303 of the stator assembly 300. For this purpose, the communication foil 507 may be glued or otherwise fixed to the stator surface 303. The communication units 501 are also electrically or data-technically connected to the respective stator modules 301 of the stator assembly 300. The connection of the communication units 501 to the stator modules 301 also provides a data connection between the communication units 501 and the main controller 201, so that the communication units 501 may be actuated or read out by the main controller 201. In an alternative embodiment, the communication units 501 may also be connected independently to an electrical supply and directly to the main controller 201 in terms of data technology.

In the embodiment shown, a communication unit 501 is arranged on each stator segment 308. This is merely exemplary and the communication units 501 may be arranged on the stator assembly 300 as desired. In particular, a plurality of communication units 501 may be arranged on each stator module 301. Also, in contrast to the arrangement in FIG. 1, the communication units 501 may not be arranged in the geometric center of the respective stator segment 308, but rather, for example, at the edge of the stator segment 308.

Preferably, the communication units 501 are arranged on the stator assembly 300 in such a way that for any position of the rotor 400 on the stator assembly 300, the rotor 400 is arranged within communication range of at least one communication unit 501. In this way, seamless communication between the main controller 201 and the rotor 400 or the sub-controller 401 of the rotor 400 may be achieved. Positions of the rotor 400 in which communication is prevented therefore do not exist on the stator assembly 300.

For seamless communication, the communication units 501 may be arranged on the stator assembly 300 in such a way that a distance between two immediately adjacent communication units 501 is less than or equal to twice the maximum communication range of the communication units 501. As an alternative or in addition, the distances at which the communication units 501 are arranged on the stator module 300 in relation to one another may be related to the dimensions of the rotor 400. Thus, distances between directly adjacent communication units 501 may be smaller than or equal to the maximum dimensions of the rotor 400, in particular the widths of the rotor 400 in the X and/or Y directions. The distances between the communication units 501 here refer to the X and Y directions running parallel to the stator surface 303.

By spacing the communication units 501 in this way, it may be provided that even with short communication ranges of the communication units 501, the rotor 400 is arranged in any position on the stator assembly 300 within the communication range of at least one communication unit 501.

According to the application, the rotor 400 is also provided with at least one rotor communication unit 402. In the embodiment shown, the rotor 400 comprises four rotor communication units 402, each of which is arranged on the four edges of the substantially rectangularly shaped rotor 400. Alternatively, the rotor 400 may have a higher or lower number of rotor communication units 402. For example, only a single rotor communication unit 402 may be arranged in a geometric center of the rotor 400 on the rotor 400.

For seamless communication between the communication units 501 and the rotor communication units 402, the communication units 501 may additionally or alternatively be arranged on the stator assembly 300 in such a way that the rotor 400 cannot be moved out of the communication range of a communication unit 501 during a control cycle when the rotor 400 is cyclically actuated and the main controller 201 cyclically communicates with the sub-controller 401 via the communication units 501 on the stator assembly 300 and the rotor communication units 402 on the rotor 400.

For this purpose, the communication units 501 may be arranged on the stator assembly 300 at distances from one another that are less than or equal to a maximum distance that the rotor 400 may travel at a maximum speed of the rotor 400 within a control cycle on the stator assembly 300. However, other arrangements of the communication units 501 on the stator assembly 300 are also conceivable and advantageous for fulfilling the described purpose. In particular, arrangements according to the previous description. In addition, it is advantageous for this purpose that the rotor 400 is embodied with a plurality of rotor communication units 402, so that at any time during the control cycle at least one rotor communication unit 402 of the rotor 400 is arranged within range of at least one communication unit 501 of the stator assembly 300.

According to an embodiment, the communication units 501 of the stator assembly 300 and the rotor communication units 402 of the rotor 400 are of the same type. In particular, the communication units 501 and rotor communication units 402 may be embodied as transmitting/receiving units that allow for both transmitting and receiving communication messages and response messages. In this way, messages may be sent from the main controller 201 to the sub-controller 401 and received by the sub-controller 401. Conversely, messages may be sent from the sub-controller 401 to the main controller 201 and received by the main controller 201.

The communication units 501 and rotor communication units 402 may, for example, be embodied as transmitting/receiving units of a near-field communication, a Bluetooth communication, a ZigBee communication or a Z-Wave communication. In general, the communication units 501 and rotor communication units 402 are advantageously embodied as radio-based transmitting/receiving units.

As an alternative to the formation of the communication units 501 in a communication foil 507, the communication units 501 may also be arranged in a communication layer. The communication layer may, for example, be embodied as an additional layer of the stator modules 301 of the stator assembly 300. For example, the communication layer may be made of a plastic material in which the communication units 501 are embedded. The communication layer may, for example, be the uppermost layer of each stator module 301 and thus form the stator surface 303 of the stator assembly 300. Alternatively, the communication layer may be integrated into the respective stator module 301 and be located inside of the stator module 301. If the communication layer is integrated into the stator assembly 300 and thus does not form the stator surface 303, the communication layer is preferably arranged directly below the stator surface. For example, the communication layer may also be embodied as an integrated circuit in a control board and integrated in the stator assembly 300.

According to a further embodiment, at least one communication unit 501 of the communication system 500 may be embodied as an external communication unit 501 which is arranged externally to the stator assembly 300 in the planar drive system 200. The external communication unit 501 may, for example, be arranged laterally next to the stator assembly 300 or mounted above the stator assembly 300 on a holder provided for this purpose. A communication range of the external communication unit 501 may be embodied to be correspondingly greater than that of the communication units 501 arranged on the stator assembly 300, in order to enable interference-free data communication with rotors 400 positioned at any point on the stator assembly 300.

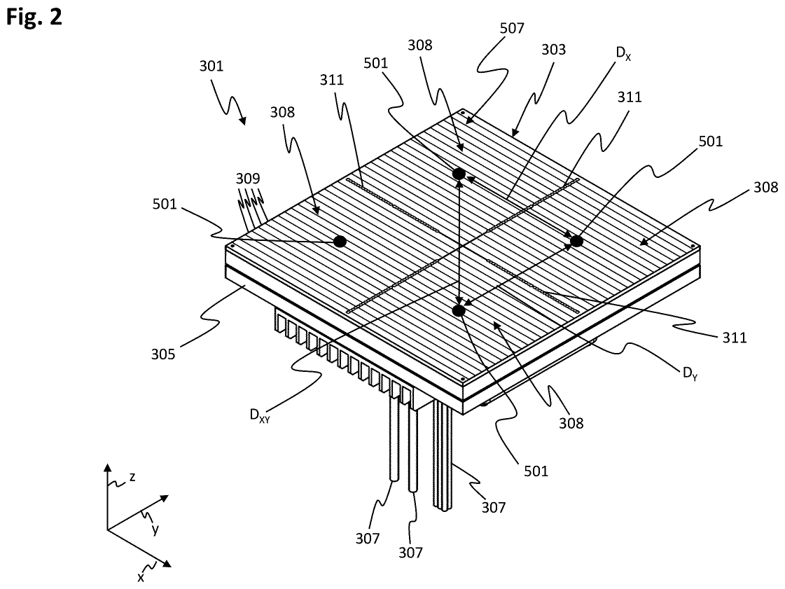

FIG. 2 shows a schematic view of a stator module 301 of the stator assembly 300 in FIG. 1.

The stator module 301 comprises four stator segments 308 having stator conductors 309 oriented along the X direction. In FIG. 2, only an uppermost layer of stator conductors 309 is shown. Below the layer of stator conductors 309 shown, at least one further layer of stator conductors 309 is arranged according to the application, which is not visible in FIG. 2. According to the application, the stator conductors 309 of the at least one further layer are oriented along the Y-direction. Furthermore, a stator module 301 may also comprise more or fewer than the four stator segments 308 shown.

The stator conductors 309 are electrically insulated from one another. The four stator segments 308 are square in shape and form a square stator surface 303. Alternatively, the stator segments 308 may also comprise a rectangular shape or any other shape. The stator segments 308 are connected to one another via a contact structure 311. In the embodiment shown, each stator segment 308 comprises a communication unit 501. The communication units 501 are each arranged in the geometric center of the stator segment 308. In the embodiment shown, the communication units 501 are arranged in a communication foil 507, which is arranged on the stator surface 303 of the stator module 301 in analogy to the embodiment in FIG. 1. Alternatively, the communication units 501 may also be arranged in a communication layer. This may, for example, be integrated as an additional layer in the stator module 301.

According to an embodiment, the communication units 501 each comprise an antenna unit, and an evaluation unit. According to an embodiment, the antenna unit and the evaluation unit of a communication unit 501 may be arranged at different positions on the stator assembly 300.

In the embodiment shown, the communication units 501 each have an X distance Dₓ along an X axis, a Y distance D_{y} along a Y axis and an XY distance D_{xy} along an XY direction. In this context, the X-axis and the Y-axis refer to a coordinate system that is fixedly connected to the stator assembly 300, wherein the XY plane of the coordinate system is oriented in parallel to the stator surface 303 of the stator assembly 300.

FIG. 3 shows a schematic depiction of an underside of a rotor 400 according to an embodiment.

During operation of the planar drive system 200, the underside of the rotor 400 is arranged facing the stator surface 303 of the stator assembly 300. The rotor 400 comprises a magnet arrangement 409 with a plurality of magnet assemblies 413 on the underside. The magnet assemblies 413 are each aligned in pairs along two mutually perpendicular directions x, y of the rotor 400 and each comprise a plurality of magnetic elements 415 arranged next to one another. The magnet arrangement 409 is embodied to generate the rotor magnetic field of the rotor 400, via which a magnetic coupling with the stator magnetic fields of the stator assembly 300 may be achieved. A drive of the rotor 400 relative to the stator assembly 300 may be achieved via the magnetic coupling.

In operation, the underside of the rotor 400 with the magnet arrangement 409 is oriented essentially in parallel to the stator surface 303 and is arranged facing the stator surface 303.

With the aid of the magnet assemblies 413 arranged along the X-direction and Y-direction, X-components, Y-components and Z-components of the rotor magnetic field may be generated. With the aid of a coupling with correspondingly oriented stator magnetic fields of the stator assembly 300, the rotor 400 may be brought into a beat over the stator surface 303 of the stator assembly 300, in which no contact of the rotor 400 with the stator assembly 300 occurs. With the aid of a corresponding control of the stator coils, the rotor 400 may be driven in the floating state relative to the stator assembly 300.

FIG. 4 shows a schematic exploded view of a stator segment 308 of a stator assembly 300. FIG. 4 shows four separate stator layers, each of which is part of the stator segment 308.

According to the embodiment shown, the stator segment 308 comprises a first stator layer 313, a second stator layer 315, a third stator layer 317 and a fourth stator layer 319 arranged one above the other in the Z direction. The first stator layer 313 and the third stator layer 317 each exclusively comprise stator conductors 309 extending in the X direction. The second stator layer 315 and the fourth stator layer 319, on the other hand, each exclusively comprise stator conductors 309 extending in the Y direction.

The stator conductors 309 of the first stator layer 313 correspond to the stator conductors 309 shown in FIG. 1 and FIG. 2, which are arranged on the stator surface 303. The stator conductors 309 of the other stator layers are arranged in the Z direction below the first stator layer 313.

The embodiment of the stator segment 308 is exemplary for the stator segments 308 shown in FIG. 1 and FIG. 2, which also have the embodiment shown in FIG. 4.

The stator conductors 309 of the individual stator layers 313, 315, 317, 319 are each combined to form coil groups 321. In the embodiment shown, each stator layer 313, 315, 317, 319 comprises three coil groups 321 arranged next to one another. The first and third stator layers 313, 317 comprise three X coil groups 323 oriented along the X direction, while the second and fourth stator layers 315, 319 comprise three Y coil groups 325 oriented along the Y direction. By corresponding energization, the X coil groups 323 are set up to generate a stator magnetic field with a Z component and a Y component, while the Y coil groups are set up to generate a stator magnetic field with a Z component and an X component. The corresponding X, Y or Z components of the stator magnetic field may be used to achieve translational movements of the rotor 400 in X, Y and Z axes and rotational movements about axes of rotation aligned parallel to the X, Y and Z axes.

The six stator conductors 309 in each coil group 321 may in particular be combined as a three-phase system, in which two interconnected stator conductors 309 each form one of the three phases U, V, W of the three-phase system.

FIG. 4 also shows a further layer of the stator segment 308, which comprises a plurality of communication units 501. In the embodiment shown, five communication units 501 are arranged in a communication layer 509. The communication layer 509 is here arranged as an uppermost layer of the stator segment 308 in the Z-direction. The communication layer 509 may thus be embodied in such a way that the stator surface 303 of the stator module 301 or the stator assembly 300 is embodied by the communication layer 509. Alternatively, a further layer may be arranged above the communication layer 509, which forms the stator surface 303. The communication layer 509 may e.g. be embodied as a circuit board. The communication layer 509 may be embodied from a plastic material, in particular in such a way that the stator module 301 or the stator assembly 300 is sealed by the communication layer 509.

In the embodiment shown, five communication units 501 are arranged in the stator segment 308 shown. This is merely exemplary and is not intended to limit the invention. According to the application, any number of communication units 501 may be arranged per stator segment 308. In particular, the number of communication units 501 per stator segment 308 may depend on the communication range of the respective communication units 501, so that a larger communication range of the communication units 501 allows for a smaller number of communication units 501 per stator segment 308, since the individual communication units 501 may each be arranged at larger distances from one another. The same applies to the entire stator assembly 300 or the stator modules 301. Depending on the number of stator modules 301 that are integrated into the stator assembly 300, and thus depending on the size of the stator assembly 300, any number of communication units 501 may be integrated into the stator assembly 300. This number may in turn depend on the respective communication range of the communication units 501.

FIG. 5 shows a flow chart of a method 100 for controlling a planar drive system 200 according to an embodiment.

The method 100 according to the application for controlling a planar drive system 200 may be implemented by a planar drive system 200 with a main controller 201, a stator assembly 300 and at least one rotor 400 with a sub-controller 401 according to the embodiments in FIGS. 1 to 4. For this purpose, the planar drive system 200 further comprises a communication system 500 having a plurality of communication units 501 and at least one rotor communication unit 402. A plurality of the communication units 501 is embodied on the stator assembly 300, while at least one rotor communication unit 402 is arranged on the rotor 400. The rotor 400 may further comprise a processing device 403 for executing the automation process to be controlled by the sub-controller 401.

As described above, the stator assembly 300 comprising a plurality of stator coils 321 for generating a stator magnetic field. The rotor 400 itself comprises a plurality of magnet assemblies 413 for generating a rotor magnetic field. The rotor 400 may be driven on the stator assembly 300 via a magnetic coupling between the stator magnetic field and the rotor magnetic field. The main controller 201 of the planar drive system 200 is set up to control the planar drive system 200 and, in particular, to control the movement of the at least one rotor 400 on the stator assembly 300. The sub-controller 401 of the rotor 400, on the other hand, is set up to control the automation process that may be carried out by the processing device 403.

The automation process may in this process be seen as a partial process of an overall process carried out by the planar drive system 200. Here, the overall process may comprise the movement of the various rotors 400 or of the at least one rotor 400 on the stator assembly 300 for transporting various goods by the at least one rotor 400. Furthermore, the overall process may include the automation process as described above, which may include, for example, a processing or manufacturing process of a good transported by the rotor 400. The control of the planar drive system 200 may thus comprise, according to the application, the movement of the rotor 400 between different positions on the stator assembly 300, as well as the execution of the automation process by the processing device 403 of the rotor 400 and the control of the automation process by the sub-controller 401 of the rotor 400.

According to the application, in order to control the planar drive system 200, the main controller 201 first transmits a communication message to the sub-controller 401 of the rotor 400 via the communication system 500 in a transmitting step 101. The communication message in this context comprises a start command for starting the automation process to be executed by the rotor 400 or by the processing device 403 of the rotor 400. In this case, the communication message is set up by the start command to cause the sub-controller 401 of the rotor 400 to start the automation process when it is received.

According to the application, after receipt of the communication message by the sub-controller 401 of the rotor 400, the automation process to be carried out is controlled by the sub-controller 401.

After receipt of the communication message by the sub-controller 401 of the rotor 400, a response message transmitted by the sub-controller 401 to the main controller 201 via the communication system 500 is received by the main controller 201 in a receiving step 103 according to the application.

In this context, the response message comprises a status information about a status of the automation process controlled by the sub-controller 401. The status information of the response message may, for example, comprise start information with the aid of which feedback is provided to the main controller 201 that the automation process has been started by the sub-controller 401 in accordance with the start command of the communication message. As an alternative or in addition, the status information may comprise stop information indicating that the automation process has been stopped.

Stopping the automation process may include, for example, ending the automation process by reaching the desired goal of the automation process. Stopping the automation process may also describe an interruption of the automation process, for example due to a malfunction of the automation process. As an alternative or in addition, the status information may comprise process data of the automation process which, for example, describe a final result or partial results of the executed automation process. The final or partial results may in turn comprise process data describing the progress of the controlled automation process. As an alternative or in addition, the status information may include an error message in which a faulty execution of the automation process is indicated. The status information may provide a precise description of the state of the automation process controlled by the sub-controller 401 and executed by the processing device 403.

The main controller 201 may take the status information of the response message into account when controlling the planar drive system 200. For example, the main controller 201 may initiate additional subsequent processes upon successful completion of the automation process executed by the processing device 403. For example, after successful completion of the automation process, the main controller 201 may move the rotor 400 to a designated position on the stator assembly 300, for example to load or remove from the rotor 400 the goods processed or produced by the automation process. Alternatively, further measures may also be initiated by the main controller 201. Overall, the bidirectional data communication between the main controller 201 and the sub-controller 401 allows the results of the automation process controlled by the sub-controller 401 to flow into the overall control of the planar drive system 200.

According to an embodiment, the main controller 201 and the sub-controller 401 each comprise a clock element. Furthermore, the communication message transmitted by the main controller 201 comprises a timestamp defined by the main controller 201. Alternatively, not every communication message comprises a time stamp. Instead, communication messages are only provided with time stamps at predetermined time intervals and thus the controllers are synchronized at the predetermined time intervals.

With the aid of the time stamp, synchronization of the two clock elements of the main controller 201 and the sub-controller 401 may be achieved. By synchronizing the two clock elements of the main controller 201 and the sub-controller 401, synchronized time recording of the two controllers 201, 401 may be achieved. By synchronizing the two clock elements of the main controller 201 and the sub-controller 401, a communication message sent out may include a start time predefined by the main controller 201 in addition to the start command for executing the automation process. In this way, it may be achieved that the automation process is started by the sub-controller 401 at the predetermined start time, which in turn may be arranged at any time later than the receipt of the communication message by the sub-controller 401. In addition, the synchronization between the main controller 201 and the sub-controllers 401 of the rotors 400 allows data exchanged to be assigned to exact points in time.

Without synchronization of the clock elements of the two controllers 201, 401, the automation process may alternatively be started by the sub-controller 401 immediately after receipt of the communication message including the start command contained therein. Alternatively, a command may be provided to the sub-controller 401 to start or stop the automation process at the end of a predetermined period of time after receipt of the respective start command.

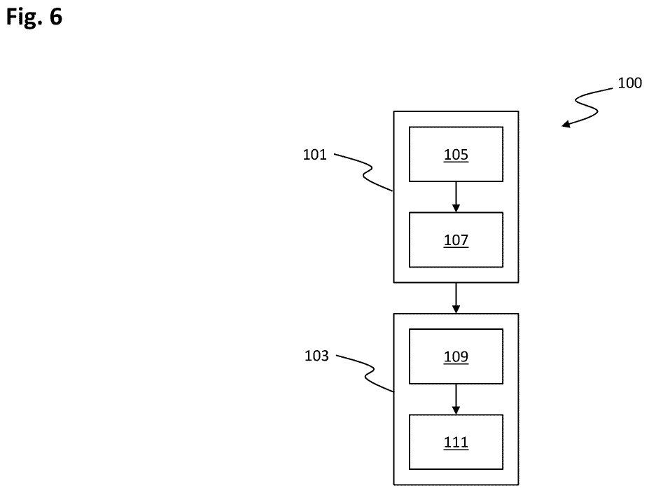

FIG. 6 shows a further flow chart of the method 100 for controlling a planar drive system 200 according to a further embodiment.

The embodiment of the method 100 according to the application shown in FIG. 6 is based on the embodiment in FIG. 5 and comprises all the method steps described therein. A further detailed description is therefore not provided below.

In the embodiment shown, the transmitting step 101 carried out by the main controller 201 comprises a determining step 105. To transmit the communication message, a communication unit 501 of the stator assembly 300 is first determined in the determining step 105 for a position of the rotor 400 on the stator assembly 300, which is arranged adjacent to the respective position of the rotor 400.

According to the application, the main controller 201 for controlling the planar drive system 200 and in particular for moving the rotor 400 on the stator assembly 300 is aware of a current position of the rotor 400 on the stator assembly 300 at all times. For this purpose, the stator assembly 300 comprises, for example, a plurality of magnetic field sensors with the aid of which the rotor magnetic field of the rotor 400 may be detected.

By detecting the rotor magnetic field in this way, the position of the rotor 400 on the stator assembly 300 may be determined accordingly. By knowing the position of the rotor relative to the stator assembly 300, the main controller 201 may determine at least one communication unit 501 for each position of the rotor 400 on the stator assembly 300, which is arranged on the stator assembly 300 adjacent to the respective position of the rotor 400. Here, a communication unit 501 is adjacent to the position of the rotor 400 if the respective communication unit 501 has a distance to the respective position of the rotor 400 that is less than a predetermined limit value. For this purpose, the main controller 201 is in turn aware of each position of each communication unit 501 of the stator assembly 300.

After determining the communication units 501 of the stator assembly 300 arranged adjacent to the current position of the rotor 400 on the stator assembly 300, the main controller 201 actuates the selected communication unit 501 to transmit the communication message to the sub-controller 401 of the rotor 400 in an actuating step 107 for transmitting the communication message. Alternatively, a plurality of communication units 501 of the stator assembly 300 adjacent to the rotor 400 in the current position may be determined in the determining step 105. Accordingly, in the activating step 107, the various selected communication units 501 may be actuated simultaneously to transmit the communication message.

As described above, the rotor 400 also comprises at least one rotor communication unit 402, which is embodied on the rotor 400. Via the at least one rotor communication unit 402, the rotor 400 is able to receive the communication message transmitted by the main controller 201. If the rotor 400 according to the embodiment in FIG. 1 comprises a plurality of rotor communication units 402, the communication message may be received via each or via a plurality of the rotor communication units 402 of the rotor 400.

In the embodiment shown, the receiving step 103 carried out by the main controller 201 further comprises a further determining step 109. In the further determining step 109, the communication units 501 arranged adjacent to the current position of the rotor 400 in the stator assembly 300 are determined and selected by the main controller 201. According to an embodiment, the determining step 105 and the further determining step 109 may be carried out in a common method step. The adjacent communication units 501 of the stator assembly 300 for transmitting the communication message to the position of the rotor 400 may also be used for receiving the response message in the receiving step 103.

This is possible in particular if the position of the rotor 400 has remained unchanged between the transmission of the communication message in the transmitting step 101 and the receipt of the response message in the receiving step 103. However, if the position of the rotor 400 is changed by moving the rotor 400 on the stator assembly 300, other communication units 501 are determined in the further determining step 109 than were determined for transmitting the communication message in the determining step 105. In particular, other communication units 501 are determined if the rotor 400 is outside a communication range of the originally determined communication unit 501.

In a reading-out step 111 carried out by the main controller 201, after determining the current position of the rotor 400, adjacent communication units 501 of the stator assembly 300 are read out and the response message is received by the main controller 201.

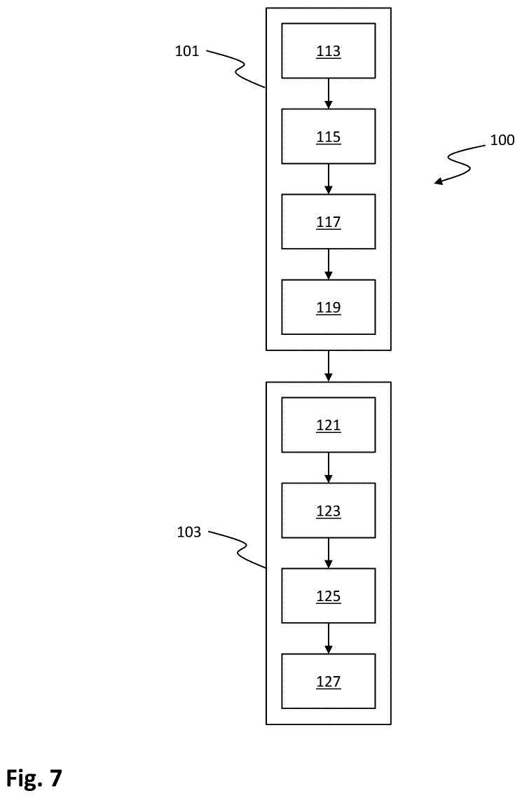

FIG. 7 shows a further flow chart of the method 100 for controlling a planar drive system 200 according to a further embodiment.

In the embodiment shown, the case of a communication between the main controller 201 and the sub-controller 401 arranged on the rotor 400 during a drive of the rotor 400 and a movement of the rotor 400 between a first position P1 and a second position P2 is described. Furthermore, the case is described in which the rotor 400 is actuated cyclically in that the rotor 400 is actuated in corresponding control cycles for moving between the first and second positions P1, P2 by the main controller 201.

The cyclic control of the planar drive system 200 further comprises the data communication between the main controller 201 and the sub-controller 401 of the rotor 400. In the embodiment shown, the case is described here in which the transmission of the communication message in the transmitting step 101 by the main controller 201 to the sub-controller 401 is not fully completed during a control cycle, so that the transmission of the entire communication message must be distributed over two consecutive control cycles. Similarly, the case is described in which the receipt of the response message transmitted by the sub-controller 401 by the main controller 201 may also not be completely executed in one control cycle, so that the receipt of the entire response message must also be executed distributed over two consecutive control cycles.

For this purpose, in the embodiment shown, the transmitting step 101 carried out by the main controller 201 comprises a first communication unit determining step 113. In the first communication unit determining step 113, first communication units 503 of the stator assembly 300 are determined, which are arranged adjacent to a first position P1 of the rotor 400 on the stator assembly 300.

In a first partial transmitting step 115, the determined first communication units 503 are then triggered to transmit a first partial communication message to the sub-controller 401 of the rotor 400. The first communication partial message here describes a part of the complete communication message and, in particular, the part that may be transmitted completely by the correspondingly determined first communication units 503 in a first control cycle of the planar drive system 200.

Since the rotor 400 is moved from the first position P1 to the second position P2 on the stator assembly 300 during the data communication, second communication units 505 are determined in a second communication unit determining step 117, which are arranged in the stator assembly 300 adjacent to the second position P2 of the rotor 400. Depending on the distance between the first and second positions P1, P2, the second communication units 505 may be at least partially identical to the first communication units 503. On the other hand, if the rotor 400 has been moved a large distance between the first position P1 and the second position P2, the first communication units 503 differ from the second communication units 505.

Subsequently, in a second partial transmitting step 119, the second communication units 505 adjacent to the second position P2 of the rotor 400 are controlled to transmit a second partial communication message. The second communication partial message describes a further part of the original communication message, in particular the part of the original communication message that could not be transmitted in the first control cycle. The second communication unit determining step 117 as well as the second partial transmitting step 119 are thus carried out in the further control cycle following the first control cycle. In the embodiment shown, the transmitting step 101 and the transmission of the communication message are distributed over two successive control cycles. By moving the rotor 400 from the first position P1 to the second position P2, the first and second communication partial messages may thus be transmitted by at least partially different first and second communication units 503, 505.

Similarly, a response message transmitted by the sub-controller 401 of the rotor 400 is received in the receiving step 103 carried out by the main controller 201 over two control cycles that follow one another in time.

For this purpose, the receiving step 103 comprises a further first communication unit determining step 121. In the further first communication unit determining step 121, the first communication units 503 arranged adjacent to the first position P1 are determined.

In a first partial reading-out step 123, the determined first communication units 503 are read out by the main controller 201 and a first partial response message is received.

In a further second communication unit determining step 125, second communication units 505 are again determined, which are arranged adjacent to the second position P2 of the rotor 400 in the stator assembly 300.

In a second partial reading-out step 127, the determined second communication units 505 are read out and a second partial response message is received by the main controller 201.

The first and second partial response messages each describe parts of the original response message to be transmitted, in particular the parts that could be transmitted by the sub-controller 401 in the two consecutive control cycles.

The first and second communication units 503, 505 adjacent to the first and second positions P1, P2 may be determined by ensuring that the corresponding communication units 501 do not exceed a predefined maximum distance to the corresponding position.

The shown transmission of the communication message in the transmitting step 101 and the receipt of the response message in the receiving step 103 may each be carried out in a distributed manner over two immediately consecutive control cycles. Alternatively, the transmission of the two communication partial messages in the transmitting step 101 or the receiving of the two response partial messages in the receiving step 103 may each be executed in a distributed manner over two control cycles of the planar drive system 200, which do not immediately follow one another in time and between which at least one further control cycle was executed.

It is also conceivable that the communication message and/or the response message could be divided up into more than two communication partial messages or more than two response partial messages. In this case, more control cycles are used for the procedure described above.

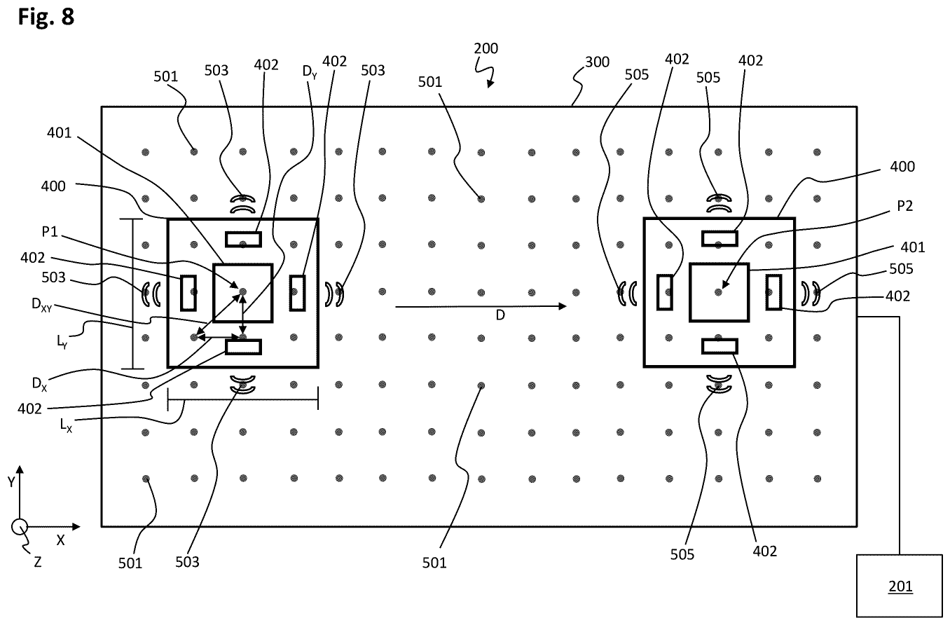

FIG. 8 shows a schematic depiction of the method 100 for controlling a planar drive system 200 according to the embodiment in FIG. 7.

FIG. 8 shows a plan view of an embodiment of the planar drive system 200 from FIG. 1. The planar drive system 200 comprises all the features described there. A further detailed description is therefore not provided below. FIG. 8 also shows a movement of a rotor 400 in a direction of travel D between a first position P1 and a second position P2.

According to the embodiment of the method 100 in FIG. 7, first communication units 503 adjacent to the first position P1 are determined. As shown, the first communication units 503 of the stator assembly 300 are characterized in that they have a distance as small as possible to the rotor communication units 402 arranged at the respective four edges of the square-shaped rotor 400. The first communication units 503 may be identified in particular by the fact that they have a distance to the first position P1 of the rotor 400 that is less than a predetermined limit value. By knowing the first position P1 of the rotor 400, which is defined with respect to a geometric center of the rotor 400 as shown, and by knowing the arrangement of the individual rotor communication units 402 on the rotor 400, the first communication units 503 may be identified as the communication units 501 of the stator assembly 300 with the smallest distance to one of the rotor communication units 402 of the rotor 400.

In the embodiment shown, data communication between the main controller 201 and the sub-controller 401 of the rotor 400 may thus take place via the determined first communication units 503 of the stator assembly 300 and the corresponding rotor communication units 402 of the rotor 400. In the illustration shown, a transmission of a response message by the rotor communication units 402 of the rotor 400 to the determined first communication units 503 of the stator assembly 300 is shown. By a corresponding readout of the first communication units 503 of the stator assembly 300 by the main controller 201, the transmitted response message may be received by the main controller 201. According to the embodiment in FIG. 7, the transmitted response message may be embodied as a first partial response message and describe only a part of the response message to be transmitted, which may be transmitted during a first control cycle.

In the embodiment shown, the communication units 501 are arranged in the stator assembly 300 in such a way that distances between directly adjacent communication units 501 are smaller than the extensions of the rotor 400. In particular, an X distance D_{X} running along an X axis is smaller than an X width Lx of the rotor 400 along the defined X direction. Similarly, a Y-distance D_{Y} between two directly adjacent communication units 501 of the stator assembly 300 along a Y-direction is smaller than a corresponding Y-width Ly of the rotor 400. An XY-distance D_{XY} between two directly adjacent communication units 501 along an XY-direction is also smaller than the planar dimensions of the square-shaped rotor 400 in the embodiment shown.

By moving the rotor 400 along the direction of travel D, the rotor 400 is positioned in a temporally subsequent control cycle in a second position P2 relative to the stator assembly 300, which differs from the first position P1. According to the embodiment in FIG. 7, corresponding second communication units 505 are determined, which are adjacent to the second position P2 of the rotor 400. In the embodiment shown, the second communication units 505 are again characterized in that they have a minimum distance to the rotor communication units 402 of the rotor 400 arranged respectively at the four edges of the square-shaped rotor 400. Also, for the second position P2, FIG. 8 again shows the transmission of a second response message from the rotor communication units 402 of the rotor 400 to the determined second communication units 505 of the stator assembly 300. By reading out the corresponding second communication units 505, the main controller 201 may receive the transmitted second response partial message accordingly.

In the embodiment shown, a situation is shown in which the first and second partial response messages were not transmitted in two immediately consecutive control cycles. Rather, the situation is shown in which the two control cycles are timed apart by a plurality of further executed control cycles. This is only done for the sake of clarity of the illustration shown and is not intended to limit the present application. In the case of two control cycles immediately following each other in time, the distance between the first and second positions P1, P2 is smaller and the first and second communication units 503, 505 may be at least partially identical.

In the illustration shown, the transmission of the response message by the sub-controller 401 of the rotor 400 is shown. According to the embodiment of the method 100 in FIG. 7, the transmission of the communication message by the main controller 201 takes place analogously via the correspondingly determined first and second communication units 503, 505 in two consecutive control cycles.

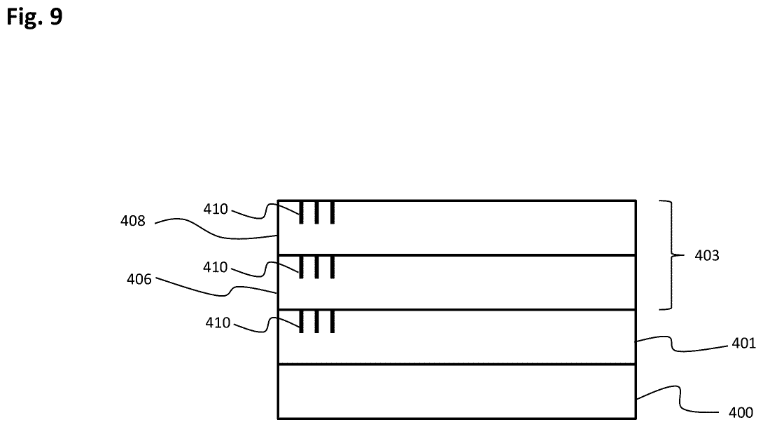

FIG. 9 shows a schematic depiction of a rotor 400 of the planar drive system 200 according to an embodiment.

In the embodiment shown, the sub-controller 401 is embodied flat on the rotor 400. In the embodiment shown, the processing device 403 for executing the automation process is also embodied flat and arranged above the sub-controller 401. In the embodiment shown, the processing device 403 comprises a first functional module 406 and a second functional module 408, which are also positioned one above the other in layers. The two functional modules 406, 408 may carry out different functions of the automation process to be controlled. Alternatively, the processing device 403 may comprise any number of different functional modules. The sub-controller 401 and the first and second functional modules 406, 408 each comprise connection elements 410, with the aid of which an electrical and data connection between the sub-controller 401 and the processing device 403 is made possible.

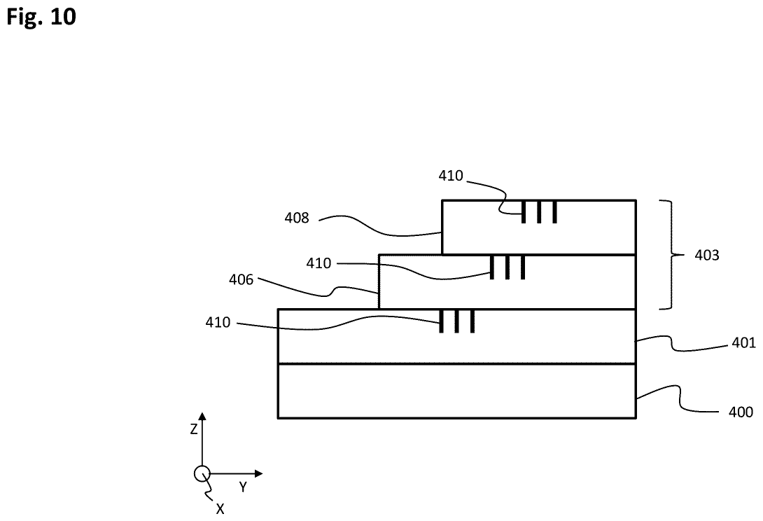

FIG. 10 shows a further schematic depiction of a rotor 400 of the planar drive system 200 according to a further embodiment.

FIG. 10 is based on the embodiment of the rotor 400 in FIG. 9 and includes all the features described there. A further detailed description is thus not provided below. In contrast to the embodiment in FIG. 9, in the embodiment in FIG. 10 the first and second functional modules 406, 408 of the processing device 403 are arranged in a step-wise manner on the sub-controller 401 embodied flat on the rotor 400.

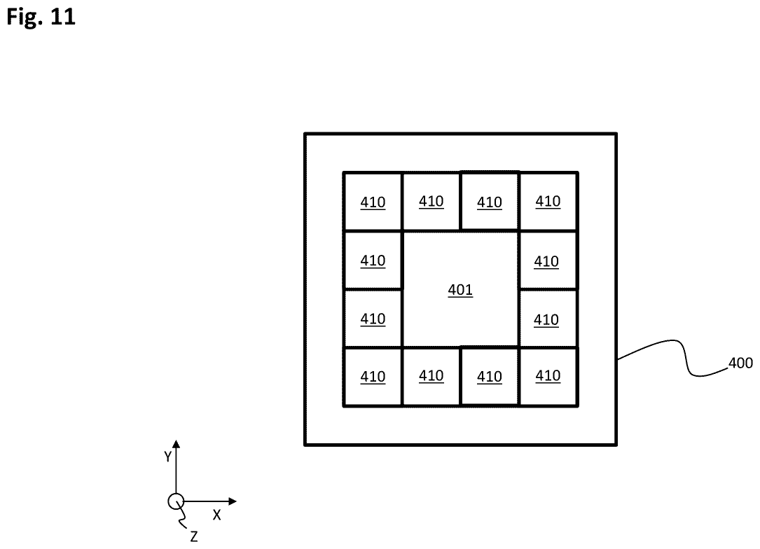

FIG. 11 shows a further schematic depiction of a rotor 400 of the planar drive system 200 according to a further embodiment.

FIG. 11 shows a top view of a rotor 400 with a flat and, in particular, rectangularly shaped sub-controller 401 arranged in the center of the rotor 400 on the rotor 400. In the embodiment shown, connecting elements 410 are arranged around the rectangularly shaped sub-controller 401. The connection elements are arranged on the four sides of the rectangular sub-controller 401. The connection elements 410 can, for example, be embodied as I/O connection elements, with the aid of which a connection of the actuator units 405 or sensor units 407 of the processing device 403 is made possible.

According to an embodiment, the sub-controller 401 and/or the processing device 403 and/or the I/O connection elements of the embodiments shown in FIGS. 9-11 are comprised by a housing unit. The housing unit may be embodied in such a way that further modules, for example further processing devices 403, may be inserted into the housing unit. For example, the housing unit may have slide-in recesses into which corresponding modules may be inserted. Furthermore, the housing unit may be embodied with contacting elements so that the various modules may be electrically and/or data-technically connected to one another via contacting with the contacting elements. The housing unit may also be connected to the rotor via a back plate.

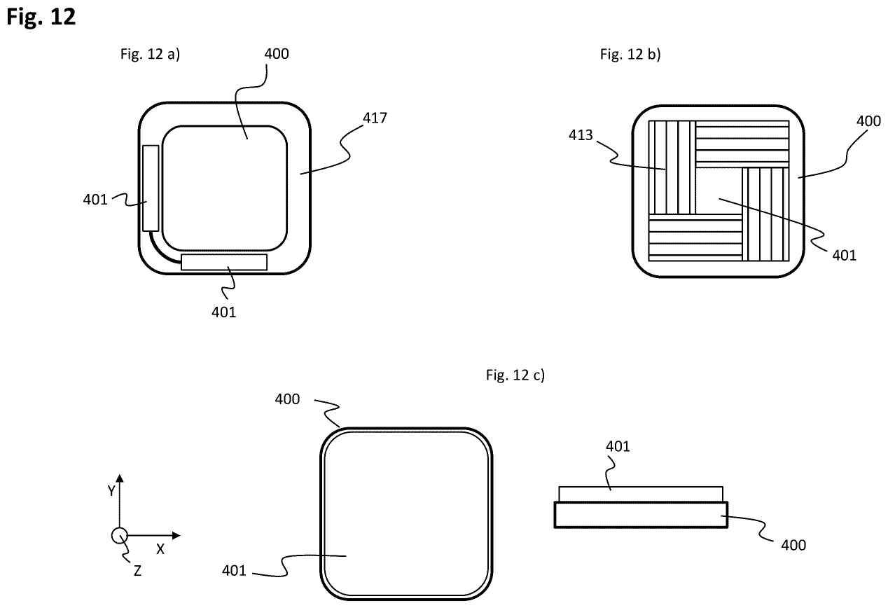

FIG. 12 shows schematic depictions of various embodiments of a sub-controller 401 of a rotor 400.

Diagram a) shows a top view of a rotor 400 with an sub-controller 401. In the embodiment shown in diagram a), the sub-controller 401 is embodied in two parts and is arranged on an edge region of the rotor 400. In particular, the sub-controller 401 is embodied in an impact protection element 417 embodied on the outer edges of the rotor 400. The impact protection element 417 serves as impact protection for the rotor 400 and prevents damage to the rotor 400 in the event of collisions of the rotor 400 with other rotors 400 or other objects. In the embodiment shown, the two-part sub-controller 401 extends over two edges of the rotor 400. It is also conceivable that only one sub-controller 401 is embodied on one edge of the rotor 400. However, it is also conceivable that the sub-controller 401 is divided up into more than two parts, in particular into four parts, and that a part of the sub-controller 401 is arranged on all four edges of the rotor 400. In this way, the installation space requirement and the weight distribution may be optimized.

Diagram b) shows a bottom view of a rotor 400 with an sub-controller 401. In the embodiment shown in diagram b), the sub-controller 401 is positioned centrally between the four magnet assemblies 413. Such an arrangement of the sub-controller is very space-saving and optimal in terms of weight distribution on the rotor 400.

Diagram c) shows a top view and a side view of a rotor 400 with a sub-controller 401. In the embodiment shown in diagram c), the sub-controller 401 is embodied as a flat layer element on the rotor 400. For this purpose, the sub-controller 401 may be embodied as a control board.

Further components, connection elements, control elements and/or objects/products to be transported may then be placed on the flat sub-controller 401 and thus moved by the rotor 400.

According to an embodiment, the sub-controller 401 is embodied as a programmable logic controller PLC. In particular, the sub-controller 401 may be embodied as an industrial PC.

According to an embodiment, the data communication between the main controller 201 and the sub-controller 401 may be carried out via a fieldbus protocol. In particular, the fieldbus protocol may be embodied as an EtherCAT protocol.

A control cycle of the cyclic control of the planar drive system 200 may describe a time duration in the microsecond range.

Although the invention has been further illustrated and described in detail by embodiments, the invention is not limited by the disclosed examples and other variations may be derived therefrom by those skilled in the art without departing from the protective scope of the invention.

TABLE 1
List of reference numerals

100 Method
101 First output step
103 Second output step
105 Third output step
107 Fourth output step
109 Fifth output step
111 Transmitting step
200 Planar drive system
201 Controller
203 Data connection
300 Stator assembly
301 Stator module
303 Stator surface
305 Stator module housing
307 Connecting cable
308 Stator segment
309 Stator conductor
311 Contact structure
313 Energy-transmitting structure
315 Basic structure
317 Transmitting unit
319 Stator base
321 Gap
323 Busbar
325 Side area of the stator assembly
327 Processing device
329 Sliding contact
331 Induction coil
333 Induction layer
335 Plug/socket element
337 Contacting element
339 Jet element
341 Supply line
343 Trigger structure
345 Activation edge
347 Recording range
349 Trigger base structure
351 Ground area
353 Contacting arm
355 Busbar film
357+ Pole contacting element
359− Pole contacting element
400 Rotors
401 Magnet assembly
403 Free surface
405 Fastening structure
407 Magnet unit
409 Magnet element
411 First X-magnet assembly
413 Second X-magnet assembly
415 First Y-magnet assembly
417 Second Y-magnet assembly
419 Energy storage
421 Energy-transmitting element
423 Further rotor
425 Energy-transmitting counter element
427 Processing device
429 Counter-transmitting unit
431 Energy-transmitting connection
433 Fixing mechanism
435 Top side
437 Underside
439 Sliding contact
441 Housing
443 Battery unit
445 Side area of the rotor
447 Induction coil
449 Induction layer
451 Plug/socket element
453 Center
455 Surrounding structure
457 Media tank
459 Insertion element
461 Top of energy storage unit
463 Side area of the energy storage unit
465 Further energy storage
467 Further energy-transmitting connection
469 Output opening
471 Trigger element
473 Ejecting element
475 Latching element
477 Rotor base
479 Side area
481 Ceiling area
500 Sensor module
501 Magnetic field sensor
D Distance
H Altitude
C Center

1. A method for controlling a planar drive system, wherein:
the planar drive system comprises a main controller for controlling the planar drive system, a stator assembly having a plurality of stator coils for generating a stator magnetic field and at least one rotor having a plurality of magnet assemblies for generating a rotor magnetic field;
wherein the rotor is drivable on the stator assembly via a magnetic coupling between the stator magnetic field and the rotor magnetic field;
wherein a sub-controller is embodied on the rotor for controlling an automation process which is executable by the rotor; and
wherein the planar drive system further comprises a communication system for wireless data communication between the main controller and the sub-controller of the rotor;
wherein the method comprises:
transmitting a communication message with the aid of the main controller to the sub-controller via the communication system in a transmitting step;
wherein the communication message comprises a start command for starting the automation process to be carried out by the rotor and is configured to drive the sub-controller to control the automation process; and
receiving a response message transmitted by the sub-controller to the main controller via the communication system in a receiving step, the response message comprising a status indication of a status of the automation process controlled by the sub-controller.

2. The method according to claim 1, wherein:
the communication system comprises a plurality of communication units arranged on the stator assembly in a distributed manner and rotor communication units arranged on the rotor in a distributed manner, and
wherein the transmitting step carried out by the main controller comprises:
determining at least one communication unit arranged adjacent to a position of the rotor on the stator assembly in a determining step; and
actuating the communication unit adjacent to the position of the rotor for transmitting the communication message in an actuating step.

3. The method according to claim 2, wherein the receiving step carried out by the main controller comprises:
determining at least one communication unit arranged adjacent to the position of the rotor on the stator module in a further determining step; and
reading out the communication unit adjacent to the position of the rotor for receiving the response message in a reading-out step.

4. The method according to claim 2, wherein:
the data communication between the main controller and the sub-controller takes place during a driving of the rotor from a first position to a second position on the stator assembly, and
wherein the transmitting step carried out by the main controller comprises:
determining at least one first communication unit arranged adjacent to the first position of the rotor on the stator assembly in a first communication unit determining step;
driving the first communication unit adjacent to the first position of the rotor to transmit a first communication partial message in a first partial transmitting step, wherein the first communication partial message represents a part of the communication message;
determining at least one second communication unit arranged adjacent to the second position of the rotor on the stator assembly in a second communication unit determining step; and
driving the second communication unit adjacent to the second position of the rotor to transmit a second communication partial message in a second partial transmitting step, wherein the second communication partial message represents a further part of the communication message;
and/or wherein the receiving step performed by the main controller comprises:
determining at least one first communication unit arranged adjacent to the first position of the rotor on the stator assembly in a further first communication unit determining step;
reading out the first communication unit adjacent to the first position of the rotor to receive a first response partial message in a first partial reading-out step, the first response partial message representing a part of the response message;
determining at least one second communication unit arranged adjacent to the second position of the rotor on the stator assembly in a further second communication unit determining step;
reading out the second communication unit adjacent to the second position of the rotor for receiving a second partial response message in a second partial reading-out step, wherein the second partial response message represents a further part of the response message.

5. The method according to claim 3, wherein the response message or partial response message received by the main controller via the communication unit is assigned to the sub-controller of the rotor based on a position of the communication unit on the stator assembly via which the response message or partial response message was received and the position of the rotor when the sub-controller transmits the response message or partial response message, or when the main controller receives the response message or partial response message.

6. The method according to claim 1, wherein:
the status information of the response message received by the main controller comprises start information that the automation process has been started;
stop information that the automation process has been stopped;
process data of the completed automation process;
process data as partial result information of the running automation process; and/or
an error message regarding an incorrect execution of the automation process.

7. The method according to claim 1, wherein:
the main controller and the sub-controller each comprise a clock element; and
wherein the communication message comprises a time stamp for synchronizing the clock elements of the main controller and the sub-controller.

8. The method according to claim 7, wherein the communication message comprises a start time for starting the execution of the automation process by the sub-controller.

9. A rotor for a planar drive system, comprising:
a stator assembly for generating a stator magnetic field for driving the rotor via magnetic coupling with a rotor magnetic field of the rotor;
the rotor comprising:
a plurality of magnet assemblies for generating the rotor magnetic field,
a sub-controller for controlling an automation process,
a processing device with at least one actuator unit and/or a sensor unit for carrying out the automation process, and
a rotor communication unit for carrying out a data communication between the sub-controller of the rotor and a main controller of the planar drive system.

10. The rotor according to claim 9, wherein the sub-controller is embodied in the form of a layer and is arranged in an evenly distributed manner over a surface of the rotor.

11. The rotor according to claim 9, wherein the sub-controller is arranged below the processing device or laterally next to the processing device.

12. A stator assembly for a planar drive system with at least one rotor, wherein:
the stator assembly comprises a plurality of stator coils for generating a stator magnetic field for driving the rotor via a magnetic coupling with a rotor magnetic field of the rotor and a plurality of communication units for wireless data communication between a main controller of the planar drive system and a sub-controller embodied on the rotor; and
wherein the communication units are arranged in an arrangement on the stator assembly.

13. The stator assembly according to claim 12, wherein a maximum distance between two adjacent communication units on the stator assembly of the arrangement is less than or equal to twice a maximum communication range of the communication unit.

14. The stator assembly according to claim 12, wherein a maximum distance between two adjacent communication units on the stator assembly is less than or equal to a minimum areal extent of a rotor of a planar drive system.

15. The stator assembly according to claim 12, wherein:
the stator coils are configured by cyclic actuation on the part of the main controller to drive the rotor at a maximum speed over a maximum distance coverable within a control cycle; and
wherein the maximum distance coverable by the rotor in a control cycle is less than or equal to a communication range of the communication units and/or less than or equal to a maximum distance between two neighboring communication units.

16. The stator assembly according to claim 12, wherein the communication units comprise transmitting/receiving units of a near field communication, a Bluetooth communication, a ZigBee communication, and/or a Z-Wave communication.

17. The stator assembly according to claim 12, wherein:
the communication units are embodied in a communication foil; and
wherein the communication foil is embodied on a stator surface of the stator assembly.

18. The stator assembly according to claim 12, wherein the communication units are integrated into the stator assembly.

19. A planar drive system comprising a main controller for controlling the planar drive system, a rotor according to claim 9 and a stator assembly, wherein the planar drive system is configured to carry out a method for controlling a planar drive system, and a communication system.

20. The planar drive system according to claim 19, wherein:
the communication system comprises at least one external communication unit; and
wherein the external communication unit is arranged at a distance from the stator assembly.
